(19) United States
(12) Patent Application Publication
(10) Pub. No.: US 2026/0278599 A1
(43) Pub. Date: Sep. 17, 2026

(54) SYSTEM FOR RECORDING TRANSACTION HISTORY OF ARTWORK

(71) Applicant: SoftBank Group Corp., Tokyo (JP)

(72) Inventor: Yuya ONO, Tokyo (JP)

(21) Appl. No.: 19/560,142

(22) Filed: Mar. 9, 2026

Related U.S. Application Data
(60) Provisional application No. 63/769,771, filed on Mar. 11, 2025.

(51) Int. Cl. G06Q 20/38; G06Q 20/36; G06Q 30/0282

(52) U.S. Cl. CPC G06Q 20/389; G06Q 20/36; G06Q 30/0282

(57) ABSTRACT

An art platform that utilizes blockchain technology and NFTs. A system is provided in which an artist uploads an artwork in a digital format and a unique digital token is generated based on the work. The generated NFT is recorded on a blockchain, enabling confirmation of the ownership and authenticity of the work. An art collector can browse and purchase works on the platform, and when a purchase is completed, the NFT is transferred to the collector's digital wallet.

### CROSS-REFERENCE TO RELATED APPLICATIONS

This application is based upon and claims the benefit of priority from U.S. Provisional Patent Application No. 63/769,771, filed on Mar. 11, 2025, the entire contents of which are incorporated herein by reference.

### BACKGROUND

Japanese Unexamined Patent Publication No. 2022-180282 discloses a method, which is a persona chatbot control method performed by at least one processor, the method including a step of receiving a user utterance, a step of adding the user utterance to a prompt including an instruction sentence associated with a description regarding a character of a chatbot, a step of encoding the prompt, and a step of inputting the encoded prompt to a language model to generate a chatbot utterance responding to the user utterance.

### SUMMARY

A problem to be solved by this disclosure is a lack of transparency in the art market and a lack of interaction between artists and art collectors. In the related art market, it was difficult to confirm the ownership and authenticity of artworks, and this was a factor that undermined the reliability of the market. In addition, there was a problem that there were few opportunities for direct communication between artists and collectors, and understanding of the value and background of the works did not deepen. By utilizing blockchain technology and NFTs (Non-Fungible Tokens), the ownership and transaction history of artworks may be recorded transparently and immutably, thereby the confirmation of authenticity may be facilitated. Furthermore, by providing a platform where artists and collectors can interact directly, it aims to deepen understanding of the works and revitalize the entire art market. This makes it possible to construct an environment where the value of artworks is properly evaluated and the creative activities of artists are more widely recognized.

Disclosed herein is a system including an input unit for an artist to upload an artwork in a digital format. This makes it possible for the artist to easily digitize their own work and publish it on the platform. Furthermore, the present invention includes a token generation unit that generates a unique digital token based on the uploaded artwork. This token generation unit issues an NFT using blockchain technology and functions as a digital certificate that proves the ownership and authenticity of the artwork. The generated digital token is recorded on the blockchain by a recording unit, whereby the transaction history and ownership transfer are transparently and immutably maintained.

In addition, the present invention includes a browsing and purchasing unit for an art collector to browse and purchase artworks, and the collector can search for works on the platform, check detailed information, and then consider purchasing. When a purchase is completed, the digital token is automatically transferred to the collector's digital wallet by a transfer unit, and ownership is transferred. This process is automated using a smart contract, and the transaction is completed quickly and securely.

Furthermore, the present invention includes a communication unit for artists and collectors to interact, where the artist can share information about their own works and production process, and the collector can provide comments and feedback. In this way, it becomes possible to provide a place for direct communication between artists and collectors, and to deepen understanding and value for artworks. By these means, an improvement in transparency in the art market and promotion of interaction between artists and collectors are realized.

### BRIEF DESCRIPTION OF THE DRAWINGS

FIG. 1 is a conceptual diagram illustrating an example of a configuration of a data processing system according to a first embodiment.

FIG. 2 is a conceptual diagram illustrating an example of main functions of a data processing apparatus and a smart device according to the first embodiment.

FIG. 3 is a conceptual diagram illustrating an example of a configuration of a data processing system according to a second embodiment.

FIG. 4 is a conceptual diagram illustrating an example of main functions of a data processing apparatus and smart glasses according to the second embodiment.

FIG. 5 is a conceptual diagram illustrating an example of a configuration of a data processing system according to a third embodiment.

FIG. 6 is a conceptual diagram illustrating an example of main functions of a data processing apparatus and a headset-type terminal according to the third embodiment.

FIG. 7 is a conceptual diagram illustrating an example of a configuration of a data processing system according to a fourth embodiment.

FIG. 8 is a conceptual diagram illustrating an example of main functions of a data processing apparatus and a robot according to the fourth embodiment.

FIG. 9 illustrates an emotion map on which a plurality of emotions are mapped.

FIG. 10 illustrates an emotion map on which a plurality of emotions are mapped.

FIG. 11 is a flowchart illustrating an example method of recording a transaction history of an artwork.

### DETAILED DESCRIPTION

Hereinafter, example systems according to the technology of the present disclosure will be described with reference to the accompanying drawings.

First, terms used in the following description will be described.

In the following embodiments, a processor with a reference sign (hereinafter, simply referred to as a “processor”) may be one arithmetic device or may be a combination of a plurality of arithmetic devices. Also, the processor may be one type of arithmetic device or may be a combination of a plurality of types of arithmetic devices. Examples of the arithmetic device include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference sign is a memory in which information is temporarily stored, and is used as a work memory by a processor.

In the following embodiments, a storage with a reference sign is one or more non-volatile storage devices that store various programs, various parameters, and the like. Examples of the non-volatile storage device include a flash memory (SSD (Solid State Drive)), a magnetic disk (for example, a hard disk), or a magnetic tape, and the like.

In the following embodiments, a communication I/F (Interface) with a reference sign is an interface including a communication processor, an antenna, and the like. The communication I/F manages communication among a plurality of computers. An example of a communication standard applied to the communication I/F includes a wireless communication standard including 5G (5th Generation Mobile Communication System), Wi-Fi (registered trademark), or Bluetooth (registered trademark), and the like.

In the following embodiments, “A and/or B” is synonymous with “at least one of A and B”. That is, “A and/or B” means that it may be A only, B only, or a combination of A and B. Also, in the present specification, when three or more matters are expressed by being connected with “and/or”, the same concept as “A and/or B” is applied.

### First Embodiment

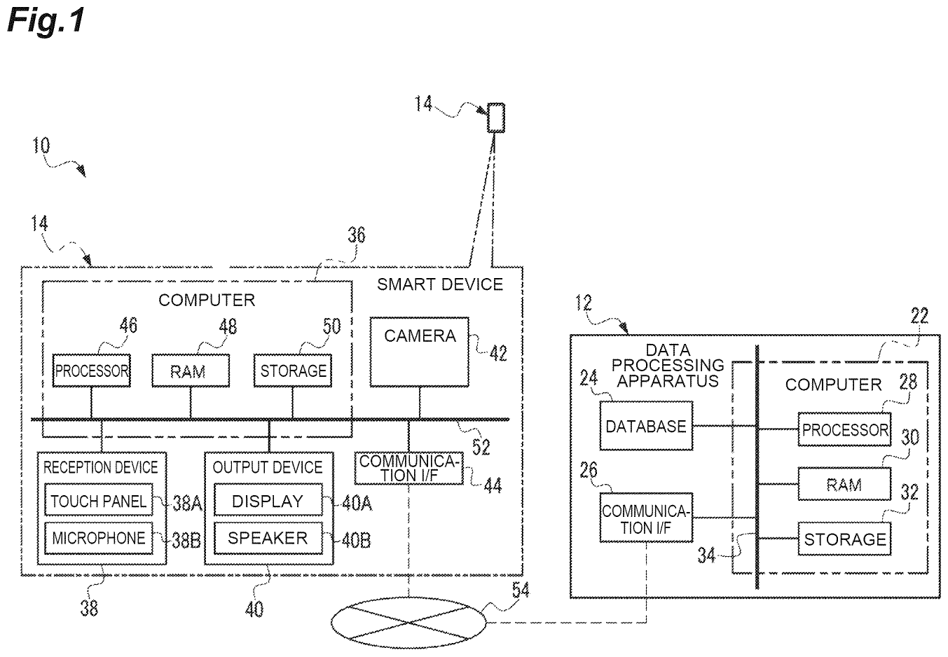

FIG. 1 illustrates an example of a configuration of a data processing system 10 according to a first embodiment.

As illustrated in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting a user's voice. A control unit 46A transmits data indicating the user input received by the touch panel 38A and the microphone 38B to the data processing apparatus 12. In the data processing apparatus 12, a specific processing unit 290 acquires the data indicating the user input.

The output device 40 includes a display 40A, a speaker 40B, and the like, and presents data to a user 20 by outputting the data in a representation form (for example, voice and/or text) perceivable by the user 20. The display 40A displays visible information such as text and images in accordance with an instruction from the processor 46. The speaker 40B outputs voice in accordance with an instruction from the processor 46. The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

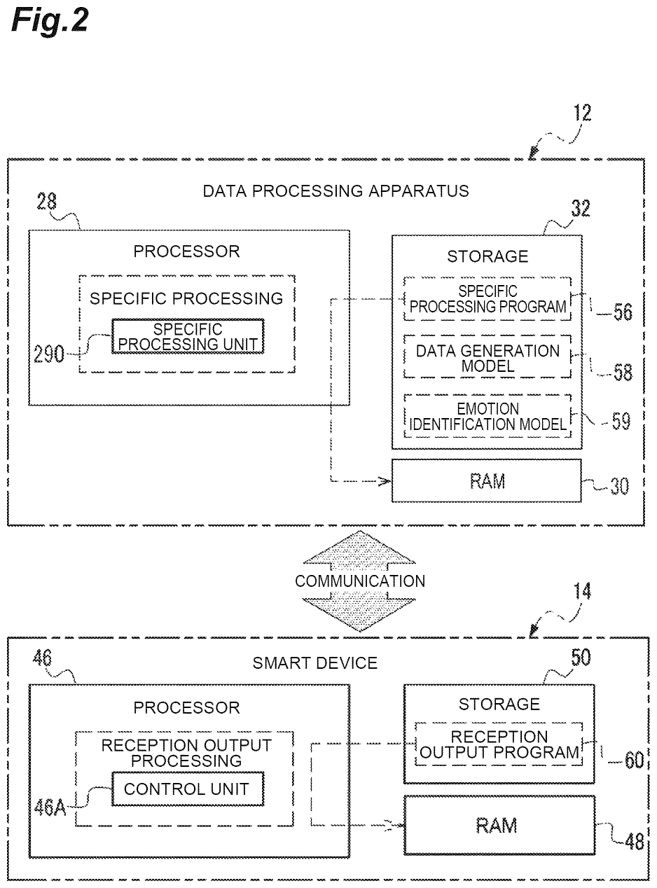

FIG. 2 illustrates an example of main functions of the data processing apparatus 12 and the smart device 14.

As illustrated in FIG. 2, in the data processing apparatus 12, specific processing is performed by the processor 28. A specific processing program 56 is stored in the storage 32. The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

In the smart device 14, reception output processing is performed by the processor 46. A reception output program 60 is stored in the storage 50. The reception output program 60 is used in combination with the specific processing program 56 by the data processing system 10. The processor 46 reads the reception output program 60 from the storage 50 and executes the read reception output program 60 on the RAM 48. The specific processing is realized by the processor 46 operating as a control unit 46A in accordance with the reception output program 60 executed on the RAM 48. Note that the smart device 14 can also have a data generation model and an emotion identification model similar to the data generation model 58 and the emotion identification model 59, and perform processing similar to that of the specific processing unit 290 using these models. The reception output processing is realized by the processor 46 operating as the control unit 46A in accordance with the reception output program 60 executed on the RAM 48.

It is preferable that the processors 28 and 46 of the computers 22 and 36 include, in addition to a CPU, a GPU (Graphics Processing Unit) or an NPU (Neural Processing Unit) specialized for parallel arithmetic processing. In particular, when the data generation model 58 and the emotion identification model 59 described later are composed of a Transformer-based Large Language Model (LLM) or a Convolutional Neural Network (CNN), inference processing of these models is executed in parallel using a plurality of arithmetic cores. The RAMs 30 and 48 include a high-speed High Bandwidth Memory (HBM) area for holding weight parameters of the models and temporary tensor data during inference. This produces a technical effect of eliminating a bottleneck in memory access and reducing latency in emotion analysis and NFT generation processing where real-time performance is required.

Note that an apparatus other than the data processing apparatus 12 may have the data generation model 58. For example, a server apparatus (for example, a generation server) may have the data generation model 58. In this case, the data processing apparatus 12 obtains a processing result (such as a prediction result) in which the data generation model 58 is used, by communicating with the server apparatus having the data generation model 58. Also, the data processing apparatus 12 may be a server apparatus, or may be a terminal device owned by a user (for example, a mobile phone, a robot, a home appliance, etc.). Next, an example of processing by the data processing system 10 according to the first embodiment will be described.

### Example 1.1

A flow of specific processing in Example 1.1 will be described. Each unit of the system described below is realized by the data processing apparatus 12 and the smart device 14. Also, the data processing apparatus 12 is referred to as a “server”, and the smart device 14 is referred to as a “terminal”.

The ArtConnect system is realized using both a server and a terminal. Hereinafter, specific embodiments of each unit will be described in detail.

First, an input unit for an artist to upload an artwork in a digital format is realized on a terminal. For example, the artist accesses the platform via a dedicated application or a web browser using their own terminal such as a computer, smartphone, or tablet. The interface on the terminal has a user-friendly design, and the artist can operate it intuitively. For example, it is possible to easily select and upload image files or video files of the work using a drag-and-drop function. At this time, it is also required to input detailed information such as the title, description, production year, techniques used, size, price setting, and number of editions of the work. This information becomes an important element for evaluating the value of the work.

Next, a token generation unit that generates a unique digital token based on the uploaded artwork is realized on the server. The server analyzes the received work data and generates an NFT using blockchain technology. This process includes creating token information including metadata of the work, hashing the token, and recording it on the blockchain. For example, a unique ID of the work and ownership information are incorporated into the token, which enables confirmation of the authenticity and ownership of the work. Furthermore, the token generation unit can set token issuance conditions that take into account the rarity and market value of the work.

A recording unit that records the generated digital token on the blockchain is also realized on the server. The server transmits the token information to the blockchain network and records it on a distributed ledger. This record is difficult to tamper with and provides a transparent transaction history. For example, the date and time when the work was first registered and information on past owners are recorded, which makes it possible to track the history of the work. The recording unit supports different blockchain protocols and can use the optimal blockchain according to the user's choice.

A browsing and purchasing unit for an art collector to browse and purchase artworks is realized on a terminal. The collector can access the platform using a terminal and browse a list of artworks. After confirming the detailed information of the work and the artist's profile, if the collector wishes to purchase, they perform the purchase procedure on the terminal. The purchase procedure includes payment by cryptocurrency or fiat currency, whereby the ownership of the work is transferred to the collector. For example, the collector can make a payment using a credit card, debit card, electronic wallet, or cryptocurrency wallet. After the purchase, the collector can check the purchase history and manage a list of owned works.

A transfer unit that transfers the digital token to the collector's digital wallet when a purchase is completed is realized on the server. The server automatically transfers the token to the collector's wallet address using a smart contract. This process is performed quickly and securely, and the transfer of ownership is reliably recorded. For example, the transfer of the token can be confirmed in real time on the blockchain, and the collector can immediately confirm the receipt of the token in their own wallet.

Finally, a communication unit for artists and collectors to interact is realized on both the server and the terminal. The server manages the sending and receiving of messages between users, and the artist and collector can communicate directly through the interface on the terminal. For example, the artist can post stories and production processes related to their own works, and the collector can provide comments and feedback. Furthermore, it is also possible for the artist and collector to have a real-time dialogue using a live chat function or a video call function. In this way, it becomes possible to provide a new place for interaction between artists and collectors, and to deepen understanding and value for artworks.

As described above, an improvement in transparency in the art market and promotion of interaction between artists and collectors may be realized by combining a server and a terminal. This makes it possible to construct an environment where the value of artworks is properly evaluated and the creative activities of artists are more widely recognized.

### (System Configuration)

The system includes an input unit, a token generation unit, a recording unit, a browsing and purchasing unit, a transfer unit, and a communication unit.

The input unit provides a function for an artist to upload an artwork in a digital format. For example, the artist accesses the platform via a dedicated application or a web browser using their own terminal such as a computer, smartphone, or tablet. This interface has a user-friendly design, and the artist can operate it intuitively. For example, it is possible to easily select and upload image files or video files of the work using a drag-and-drop function. Also, it is required to input detailed information such as the title, description, production year, techniques used, size, price setting, and number of editions of the work. This information becomes an important element for evaluating the value of the work. Furthermore, the input unit is also provided with a function to perform automatic tagging of the work utilizing AI to improve searchability.

The input unit may be configured by, for example, the reception device 38, the camera 40, or the like of the smart device 14.

The token generation unit generates a unique digital token based on the uploaded artwork. The server analyzes the received work data and generates an NFT using blockchain technology. This process includes creating token information including metadata of the work, hashing the token, and recording it on the blockchain. For example, a unique ID of the work and ownership information are incorporated into the token, which enables confirmation of the authenticity and ownership of the work. Furthermore, the token generation unit can set token issuance conditions that take into account the rarity and market value of the work. A specific example of a prompt sentence to be read into the generative AI is, “Analyze the metadata of this artwork and generate a unique NFT. Please create the optimal token information, considering the work's ID, ownership information, and rarity.”.

The token generation unit may be configured by, for example, the computer 22 (processor 28, etc.) of the data processing apparatus 12, or may be configured by the specific processing unit 290, the specific processing program 56, or the like.

The NFT generation process by the token generation unit includes the following specific steps: (1) calculating a unique hash value for digital data of an uploaded artwork using a cryptographic hash function such as SHA-256; (2) storing the digital data in a distributed storage such as IPFS (InterPlanetary File System) and obtaining a content address (CID) thereof; (3) generating a metadata structure including the hash value, the CID, and signature data of an artist; and (4) calling a Mint Function of a smart contract (for example, ERC-721 compliant) on a blockchain with the metadata structure as an argument. Thereby, entity data of the artwork and a token on the blockchain are cryptographically and inseparably linked, and tamper detection and proof of authenticity of data are mathematically guaranteed.

The recording unit provides a function to record the generated digital token on the blockchain. The server transmits the token information to the blockchain network and records it on a distributed ledger. This record is difficult to tamper with and provides a transparent transaction history. For example, the date and time when the work was first registered and information on past owners are recorded, which makes it possible to track the history of the work. The recording unit supports different blockchain protocols and can use the optimal blockchain according to the user's choice. Furthermore, the recording unit employs an optimized data structure to improve transaction efficiency.

The browsing and purchasing unit provides a function for an art collector to browse and purchase artworks. The collector can access the platform using a terminal and browse a list of artworks. After confirming the detailed information of the work and the artist's profile, if the collector wishes to purchase, they perform the purchase procedure on the terminal. The purchase procedure includes payment by cryptocurrency or fiat currency, whereby the ownership of the work is transferred to the collector. For example, the collector can make a payment using a credit card, debit card, electronic wallet, or cryptocurrency wallet. After the purchase, the collector can check the purchase history and manage a list of owned works. Furthermore, the browsing and purchasing unit provides a recommendation function for works based on the collector's preferences utilizing AI.

The browsing and purchasing unit may be configured by, for example, the reception device 38 or the like of the smart device 14.

The transfer unit provides a function to transfer the digital token to the collector's digital wallet when a purchase is completed. The server automatically transfers the token to the collector's wallet address using a smart contract. This process is performed quickly and securely, and the transfer of ownership is reliably recorded. For example, the transfer of the token can be confirmed in real time on the blockchain, and the collector can immediately confirm the receipt of the token in their own wallet. The transfer unit supports different wallet providers and can use the optimal wallet according to the user's choice.

The transfer unit may be configured by, for example, the computer 22 (processor 28, etc.) and the communication I/F 26 of the data processing apparatus 12, or may be configured by the specific processing unit 290, the specific processing program 56, or the like.

The communication unit provides a function for artists and collectors to interact. The server manages the sending and receiving of messages between users, and the artist and collector can communicate directly through the interface on the terminal. For example, the artist can post stories and production processes related to their own works, and the collector can provide comments and feedback. Furthermore, it is also possible for the artist and collector to have a real-time dialogue using a live chat function or a video call function. The communication unit provides a recommendation function for content based on user interests utilizing AI and promotes interaction. A specific example of a prompt sentence to be read into the generative AI is, “Design an optimal interface to promote real-time communication between artists and collectors. Please recommend content based on user interests and activate interaction.”

The communication unit may be configured by the computer 22 (processor 28, etc.) and the communication I/F 26 of the data processing apparatus 12, and the computer 36 (processor 46) and the communication I/F 44 of the smart device 14.

As described above, the system according to the present embodiment is one in which each unit cooperates to realize an improvement in transparency in the art market and promotion of interaction between artists and collectors. This makes it possible to construct an environment where the value of artworks is properly evaluated and the creative activities of artists are more widely recognized.

### (Implementation Steps)

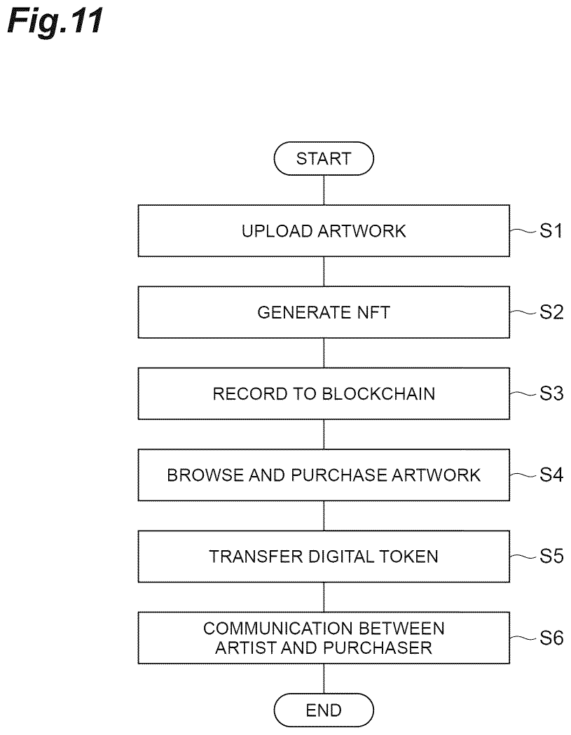

### Step 1: Uploading of Artwork (Refer to Step S1 of FIG. 11)

An artist accesses the platform via a dedicated application or a web browser using their own terminal such as a computer, smartphone, or tablet. Through a user-friendly interface, the artist can easily select and upload image files or video files of the work using a drag-and-drop function. Also, it is required to input detailed information such as the title, description, production year, techniques used, size, price setting, and number of editions of the work. This information becomes an important element for evaluating the value of the work. Furthermore, a function to perform automatic tagging of the work utilizing AI to improve searchability is also provided.

### Step 2: Generation of NFT (Refer to Step S2 of FIG. 11)

A unique digital token is generated on the server based on the uploaded artwork. The server analyzes the received work data and generates an NFT using blockchain technology. This process includes creating token information including metadata of the work, hashing the token, and recording it on the blockchain. For example, a unique ID of the work and ownership information are incorporated into the token, which enables confirmation of the authenticity and ownership of the work. A specific example of a prompt sentence to be read into the generative AI is, “Analyze the metadata of this artwork and generate a unique NFT. Please create the optimal token information, considering the work's ID, ownership information, and rarity.”.

### Step 3: Recording on Blockchain (Refer to Step S3 of FIG. 11)

The generated digital token is recorded on the blockchain. The server transmits the token information to the blockchain network and records it on a distributed ledger. This record is difficult to tamper with and provides a transparent transaction history. For example, the date and time when the work was first registered and information on past owners are recorded, which makes it possible to track the history of the work. The recording unit supports different blockchain protocols and can use the optimal blockchain according to the user's choice.

### Step 4: Browsing and Purchasing of Artwork (Refer to Step S4 of FIG. 11)

An art collector can access the platform using a terminal and browse a list of artworks. After confirming the detailed information of the work and the artist's profile, if the collector wishes to purchase, they perform the purchase procedure on the terminal. The purchase procedure includes payment by cryptocurrency or fiat currency, whereby the ownership of the work is transferred to the collector. For example, the collector can make a payment using a credit card, debit card, electronic wallet, or cryptocurrency wallet. After the purchase, the collector can check the purchase history and manage a list of owned works. Furthermore, a recommendation function for works based on the collector's preferences utilizing AI is provided.

### Step 5: Transfer of Digital Token (Refer to Step S5 of FIG. 11)

When a purchase is completed, the digital token is transferred to the collector's digital wallet. The server automatically transfers the token to the collector's wallet address using a smart contract. This process is performed quickly and securely, and the transfer of ownership is reliably recorded. For example, the transfer of the token can be confirmed in real time on the blockchain, and the collector can immediately confirm the receipt of the token in their own wallet.

### Step 6: Interaction Between Artist and Collector (Refer to Step S6 of FIG. 11)

A function for artists and collectors to interact is provided. The server manages the sending and receiving of messages between users, and the artist and collector can communicate directly through the interface on the terminal. For example, the artist can post stories and production processes related to their own works, and the collector can provide comments and feedback. Furthermore, it is also possible for the artist and collector to have a real-time dialogue using a live chat function or a video call function. A specific example of a prompt sentence to be read into the generative AI is, “Design an optimal interface to promote real-time communication between artists and collectors. Please recommend content based on user interests and activate interaction.”

### (Specific Use Case)

For example, in a case where an artist creates a new digital artwork and wants to make the work widely known and sell it at an appropriate price, the system can be used. The artist first accesses the platform via a dedicated application or a web browser using their own computer or smartphone. Through a user-friendly interface, the artist selects and uploads an image file of the work using a drag-and-drop function. Furthermore, the artist inputs detailed information such as the title, description, production year, techniques used, size, price setting, and number of editions of the work. This prepares the basic information for evaluating the value of the work.

Next, a unique digital token is generated on the server based on the uploaded work. The server analyzes the received work data and generates an NFT using blockchain technology. This process includes creating token information including metadata of the work, hashing the token, and recording it on the blockchain. A specific example of a prompt sentence to be read into the generative AI is, “Analyze the metadata of this artwork and generate a unique NFT. Please create the optimal token information, considering the work's ID, ownership information, and rarity”.

The generated digital token is recorded on the blockchain and provides a transaction history that is difficult to tamper with and highly transparent. This facilitates the confirmation of the authenticity and ownership of the work. An art collector can access the platform using a terminal and browse a list of artworks. After confirming the detailed information of the work and the artist's profile, if the collector wishes to purchase, they perform the purchase procedure on the terminal. The purchase procedure includes payment by cryptocurrency or fiat currency, whereby the ownership of the work is transferred to the collector.

When a purchase is completed, the digital token is transferred to the collector's digital wallet. The server automatically transfers the token to the collector's wallet address using a smart contract. This process is performed quickly and securely, and the transfer of ownership is reliably recorded. Furthermore, the artist and collector can communicate directly on the platform. The artist can post stories and production processes related to their own works, and the collector can provide comments and feedback. A specific example of a prompt sentence to be read into the generative AI is, “Design an optimal interface to promote real-time communication between artists and collectors. Please recommend content based on user interests and activate interaction.”.

In this way, the system provides an effective means for properly evaluating the value of artworks and making the creative activities of artists widely known. This realizes an improvement in transparency in the art market and promotion of interaction between artists and collectors.

### Example 1.2

A flow of specific processing in Example 1.2 will be described. Each unit of the system described below is realized by the data processing apparatus 12 and the smart device 14. Also, the data processing apparatus 12 is referred to as a “server”, and the smart device 14 is referred to as a “terminal”.

A system that realizes transactions of digital products in a virtual store is configured as follows.

First, an input unit for registering a digital product is provided. This input unit is used when an operator of a virtual store registers a digital product on the platform. For example, the operator accesses the platform via a dedicated application or a web interface using a terminal such as a computer or a tablet. For example, in the case of digital art, it is required to upload a high-resolution image file of the work and input detailed information such as the title, a detailed description, the creator's background, the price, sales conditions, usage rights, and the number of editions. This prepares the basic information for evaluating the value of the product. Furthermore, for a music work, it is possible to register a sample sound source or a full version of the song, profiles of the composer and performers, the release date, the genre, license information, and the like.

Next, a token generation unit that generates a unique digital token based on the registered digital product is provided. This token generation unit operates on a server, analyzes the metadata of the product, and generates an NFT using blockchain technology. For example, in the case of a video work, the resolution, format, information on the director and cast, running time, release date, and the like are included in the token. This process incorporates a unique ID of the product and ownership information into the token, which enables confirmation of the authenticity and ownership of the product. The token generation unit can set token issuance conditions that take into account the rarity and market value of the product utilizing AI.

The generated digital token is recorded on the blockchain by a recording unit. This recording unit plays a role in transmitting the token information to the blockchain network and recording it on a distributed ledger. For example, since past owners and transaction history can be confirmed on the blockchain, a purchaser can track the history of the product. The recording unit supports different blockchain protocols and can use the optimal blockchain according to the user's choice. Furthermore, the recording unit employs an optimized data structure to improve transaction efficiency.

Furthermore, a browsing and purchasing unit for browsing and purchasing a digital product is provided. A user of the virtual store can access the platform using a terminal and browse a list of digital products. For example, the purchaser can make a payment using a credit card or cryptocurrency and immediately acquire ownership of the product. When a purchase is completed, the digital token is transferred to the purchaser's digital wallet, and ownership is transferred. This process is automated using a smart contract, and the transaction is completed quickly and securely. The purchaser can check the purchase history and manage a list of owned digital products.

Finally, a communication unit for promoting interaction between users is provided. This communication unit provides a function for a purchaser to post reviews and feedback on a digital product and exchange opinions with other users. For example, it is possible to share impressions about purchased digital art or evaluations of a music work. Furthermore, it is also possible for an artist and a purchaser to have a real-time dialogue using a live chat function or a video call function. The communication unit provides a recommendation function for content based on user interests utilizing AI and promotes interaction.

In this way, a more attractive purchasing experience may be provided by improving transparency and reliability in the transaction of digital products in a virtual store, as well as promoting interaction between users. This allows the value of digital products to be properly evaluated and promotes the revitalization of the entire virtual store.

### (System Configuration)

The system includes an input unit, a token generation unit, a recording unit, a browsing and purchasing unit, a transfer unit, and a communication unit.

The input unit is used when an operator of a virtual store registers a digital product on the platform. For example, the operator accesses the platform via a dedicated application or a web interface using a terminal such as a computer or a tablet. This interface has a user-friendly design, and the operator can operate it intuitively. For example, in the case of digital art, it is required to upload a high-resolution image file of the work and input detailed information such as the title, a detailed description, the creator's background, the price, sales conditions, usage rights, and the number of editions. For a music work, it is possible to register a sample sound source or a full version of the song, profiles of the composer and performers, the release date, the genre, license information, and the like. Furthermore, in the case of a video work, it is required to input the resolution, format, information on the director and cast, running time, release date, and the like.

The token generation unit generates a unique digital token based on the registered digital product. This token generation unit operates on a server, analyzes the metadata of the product, and generates an NFT using blockchain technology. For example, a unique ID of the product and ownership information are incorporated into the token, which enables confirmation of the authenticity and ownership of the product. The token generation unit can set token issuance conditions that take into account the rarity and market value of the product utilizing AI. A specific example of a prompt sentence to be read into the generative AI is, “Analyze the metadata of the product and generate a unique NFT. Please create the optimal token information, considering the product's ID, ownership information, and rarity.”.

The recording unit records the generated digital token on the blockchain. This recording unit plays a role in transmitting the token information to the blockchain network and recording it on a distributed ledger. For example, since past owners and transaction history can be confirmed on the blockchain, a purchaser can track the history of the product. The recording unit supports different blockchain protocols and can use the optimal blockchain according to the user's choice. Furthermore, the recording unit employs an optimized data structure to improve transaction efficiency.

The browsing and purchasing unit provides a function for browsing and purchasing a digital product. A user of the virtual store can access the platform using a terminal and browse a list of digital products. For example, the purchaser can make a payment using a credit card or cryptocurrency and immediately acquire ownership of the product. When a purchase is completed, the digital token is transferred to the purchaser's digital wallet, and ownership is transferred. This process is automated using a smart contract, and the transaction is completed quickly and securely. The purchaser can check the purchase history and manage a list of owned digital products.

The transfer unit provides a function to transfer the digital token to the purchaser's digital wallet when a purchase is completed. The server automatically transfers the token to the purchaser's wallet address using a smart contract. This process is performed quickly and securely, and the transfer of ownership is reliably recorded. For example, the transfer of the token can be confirmed in real time on the blockchain, and the purchaser can immediately confirm the receipt of the token in their own wallet. The transfer unit supports different wallet providers and can use the optimal wallet according to the user's choice.

The communication unit provides a function for promoting interaction between users. This communication unit provides a function for a purchaser to post reviews and feedback on a digital product and exchange opinions with other users. For example, it is possible to share impressions about purchased digital art or evaluations of a music work. Furthermore, it is also possible for an artist and a purchaser to have a real-time dialogue using a live chat function or a video call function. The communication unit provides a recommendation function for content based on user interests utilizing AI and promotes interaction. A specific example of a prompt sentence to be read into the generative AI is, “Design an optimal interface to promote interaction between users. Please recommend content based on user interests and activate interaction”.

In this way, the system according to the present embodiment is one in which each unit cooperates to provide a more attractive purchasing experience by improving transparency and reliability in the transaction of digital products in a virtual store, as well as promoting interaction between users. This allows the value of digital products to be properly evaluated and promotes the revitalization of the entire virtual store.

### (Implementation Steps)

### Step 1: Registration of Digital Product

An operator of a virtual store accesses a dedicated application or a web interface using a terminal such as a computer or a tablet to register a digital product on the platform. The operator uploads a high-resolution image file of digital art, a sample sound source of a music work, or a video file of a video work through a user-friendly interface. Furthermore, the operator inputs detailed information such as the title, a detailed description, the creator's background, the price, sales conditions, usage rights, and the number of editions of the product. This prepares the basic information for evaluating the value of the product.

### Step 2: Generation of NFT

A unique digital token is generated on the server based on the registered digital product. The token generation unit analyzes the metadata of the product and generates an NFT using blockchain technology. This process incorporates a unique ID of the product and ownership information into the token, enabling confirmation of the authenticity and ownership of the product. A specific example of a prompt sentence to be read into the generative AI is, “Analyze the metadata of the product and generate a unique NFT. Please create the optimal token information, considering the product's ID, ownership information, and rarity.”.

### Step 3: Recording on Blockchain

The generated digital token is recorded on the blockchain by the recording unit. The recording unit plays a role in transmitting the token information to the blockchain network and recording it on a distributed ledger. This allows past owners and transaction history to be confirmed on the blockchain, and a purchaser can track the history of the product. The recording unit supports different blockchain protocols and can use the optimal blockchain according to the user's choice.

### Step 4: Browsing and Purchasing of Digital Product

A user of the virtual store can access the platform using a terminal and browse a list of digital products. The purchaser can make a payment using a credit card or cryptocurrency and immediately acquire ownership of the product. When a purchase is completed, the digital token is transferred to the purchaser's digital wallet, and ownership is transferred. This process is automated using a smart contract, and the transaction is completed quickly and securely. The purchaser can check the purchase history and manage a list of owned digital products.

### Step 5: Transfer of Digital Token

When a purchase is completed, the digital token is transferred to the purchaser's digital wallet. The server automatically transfers the token to the purchaser's wallet address using a smart contract. This process is performed quickly and securely, and the transfer of ownership is reliably recorded. The transfer of the token can be confirmed in real time on the blockchain, and the purchaser can immediately confirm the receipt of the token in their own wallet.

### Step 6: Promotion of Interaction Between Users

The communication unit provides a function for a purchaser to post reviews and feedback on a digital product and exchange opinions with other users. It is possible to share impressions about purchased digital art or evaluations of a music work. Furthermore, it is also possible for an artist and a purchaser to have a real-time dialogue using a live chat function or a video call function. A specific example of a prompt sentence to be read into the generative AI is, “Design an optimal interface to promote interaction between users. Please recommend content based on user interests and activate interaction.”.

### (Specific Use Case)

For example, suppose a certain virtual store operates a platform for selling digital artworks. This store utilizes the system to support artists in making their works widely known and selling them at an appropriate price. The artist accesses the platform through a dedicated application and uploads a high-resolution image of the work. Furthermore, the artist inputs information such as the title, a detailed description, the creator's background, the price, sales conditions, usage rights, and the number of editions of the work. This prepares the basic information for evaluating the value of the work.

Next, the system generates a unique digital token based on the registered work. The token generation unit analyzes the metadata of the work and generates an NFT using blockchain technology. This process incorporates a unique ID of the work and ownership information into the token, which enables confirmation of the authenticity and ownership of the work. A specific example of a prompt sentence to be read into the generative AI is, “Analyze the metadata of this digital artwork and generate a unique NFT. Please create the optimal token information, considering the work's ID, ownership information, and rarity.”.

The generated digital token is recorded on the blockchain by the recording unit. This allows past owners and transaction history to be confirmed on the blockchain, and a purchaser can track the history of the work. A user of the virtual store browses the work on the platform, and if they wish to purchase, they make a payment using a credit card or cryptocurrency. When a purchase is completed, the digital token is transferred to the purchaser's digital wallet, and ownership is transferred. This process is automated using a smart contract, and the transaction is completed quickly and securely.

Furthermore, the purchaser can post reviews and feedback on the work on the platform and exchange opinions with other users. For example, it is possible to share impressions about the purchased digital art or evaluations of the work. This deepens the understanding of the value of the work and promotes the revitalization of the entire virtual store. A specific example of a prompt sentence to be read into the generative AI is, “Design an optimal interface to promote interaction between users. Please recommend content based on user interests and activate interaction.”.

In this way, the system provides a more attractive purchasing experience by improving transparency and reliability in the transaction of digital artworks in a virtual store, as well as promoting interaction between users. This makes it possible to construct an environment where the value of digital artworks is properly evaluated and the creative activities of artists are more widely recognized.

The specific processing unit 290 transmits a result of the specific processing to the smart device 14. In the smart device 14, the control unit 46A causes the output device 40 to output the result of the specific processing. The microphone 38B acquires voice indicating a user input for the result of the specific processing. The control unit 46A transmits voice data indicating the user input acquired by the microphone 38B to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the smart device 14.

### Second Embodiment

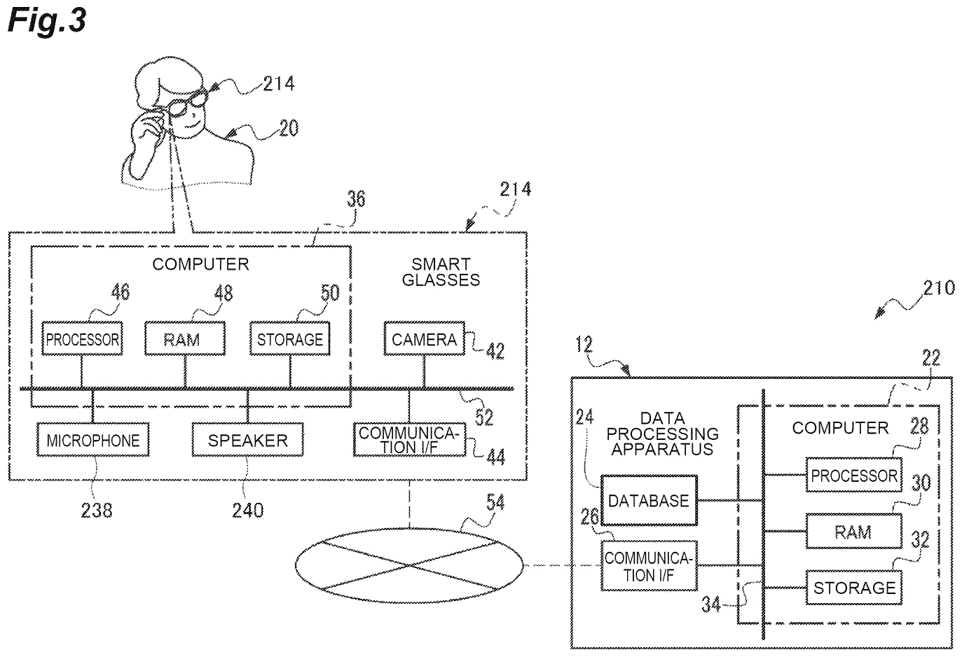

FIG. 3 illustrates an example of a configuration of a data processing system 210 according to a second embodiment.

As illustrated in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

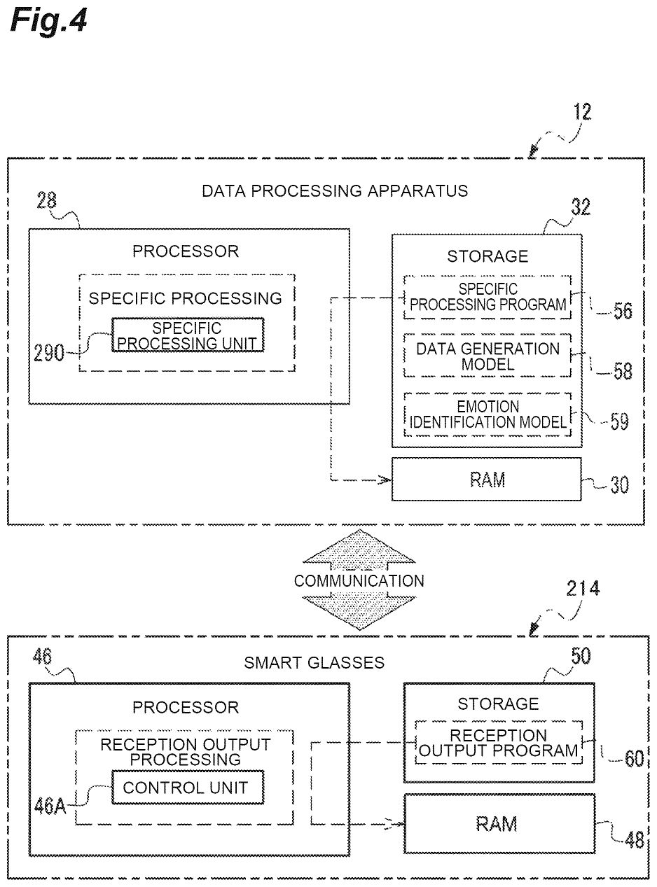

FIG. 4 illustrates an example of main functions of the data processing apparatus 12 and the smart glasses 214. As illustrated in FIG. 4, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

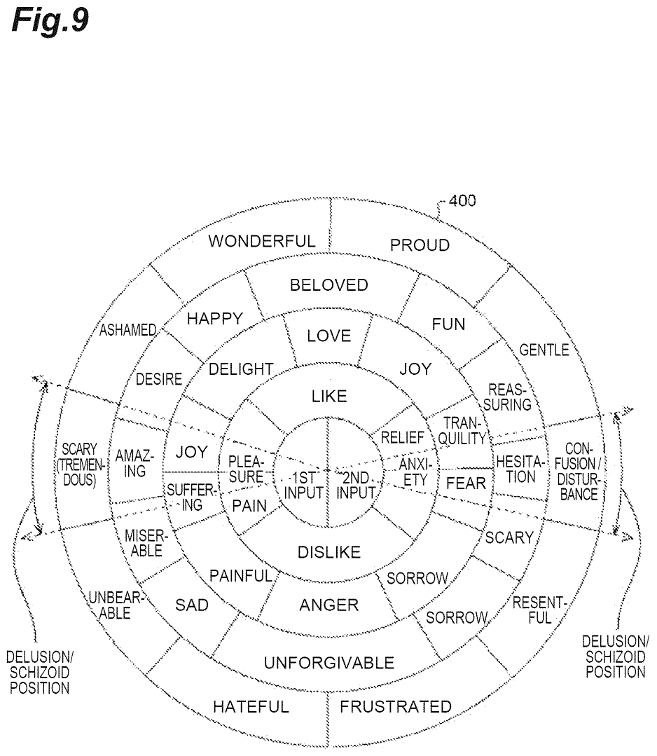

The data generation model 58 and the emotion identification model 59 may adopt a Transformer architecture having a multi-layer Attention mechanism. The specific processing unit 290 may convert input voice data (waveform data) into Mel-Frequency Cepstral Coefficients (MFCC), tokenize the coefficients, and input them to the model. Inside the model, a long-range dependency within time-series data is calculated by a Self-Attention mechanism, and a feature vector in which context information and prosodic information (pitch, tone) are integrated can be generated. This feature vector is mapped to a coordinate space (vector space) on the emotion map 400 shown in FIG. 9. Unlike a subjective judgment process performed in a human brain, this process is an objective classification process based on mathematical distance calculation (cosine similarity, etc.) in a high-dimensional vector space, and it is practically impossible for a human to perform it as a mental process.

In the smart glasses 214, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48. Note that the smart glasses 214 can also have a data generation model and an emotion identification model similar to the data generation model 58 and the emotion identification model 59, and perform processing similar to that of the specific processing unit 290 using these models.

Next, specific processing by the specific processing unit 290 of the data processing apparatus 12 will be described. Each unit of the system described below is realized by the data processing apparatus 12 and the smart glasses 214. In the following description, the data processing apparatus 12 is referred to as a “server”, and the smart glasses 214 are referred to as a “terminal”.

### Example 2.1

Since the flow of the specific processing is the same as that in Example 1.1 described in the first embodiment, a description thereof is omitted.

### Example 2.2

Since the flow of the specific processing is the same as that in Example 1.2 described in the first embodiment, a description thereof is omitted.

The specific processing unit 290 transmits a result of the specific processing to the smart glasses 214. In the smart glasses 214, the control unit 46A causes the speaker 240 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the smart glasses 214.

### Third Embodiment

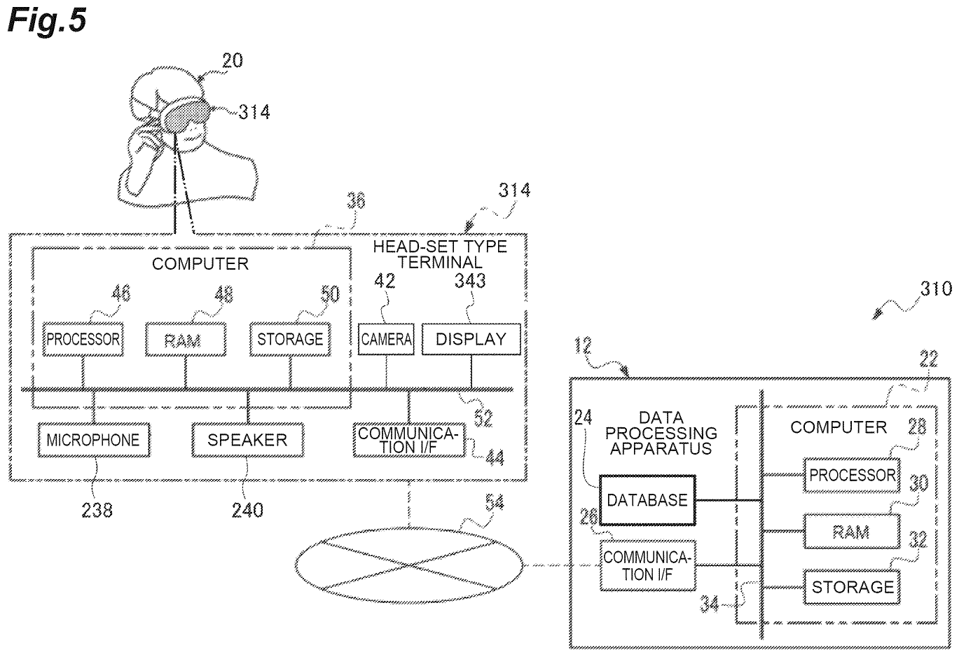

FIG. 5 illustrates an example of a configuration of a data processing system 310 according to a third embodiment.

As illustrated in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

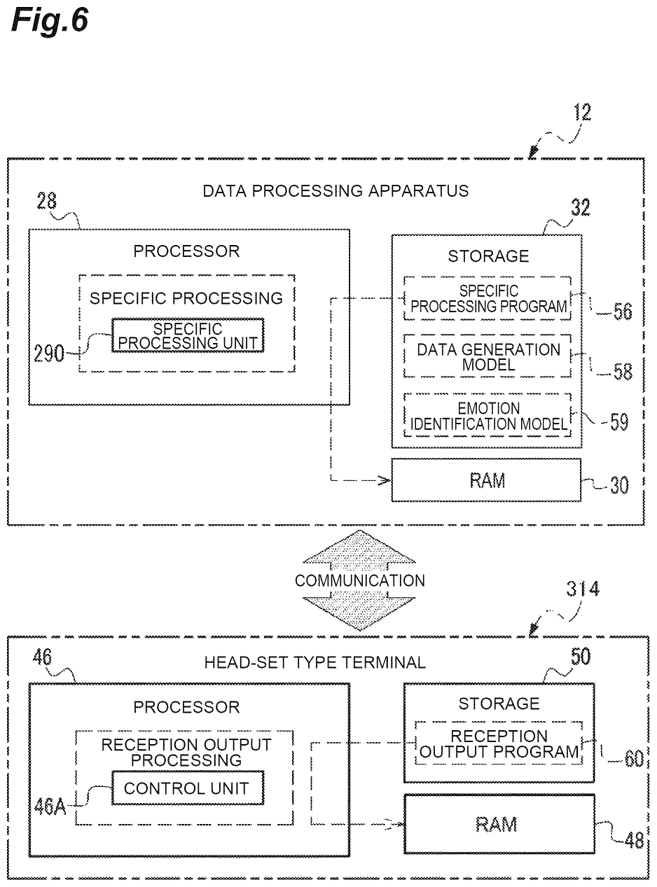

FIG. 6 illustrates an example of main functions of the data processing apparatus 12 and the headset-type terminal 314. As illustrated in FIG. 6, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the headset-type terminal 314, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the headset-type terminal 314. In the following description, the data processing apparatus 12 is referred to as a “server”, and the headset-type terminal 314 is referred to as a “terminal”.

### Example 3.1

Since the flow of the specific processing is the same as that in Example 1.1 described in the first embodiment, a description thereof is omitted.

### Example 3.2

Since the flow of the specific processing is the same as that in Example 1.2 described in the first embodiment, a description thereof is omitted.

The specific processing unit 290 transmits a result of the specific processing to the headset-type terminal 314. In the headset-type terminal 314, the control unit 46A causes the speaker 240 and the display 343 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the headset-type terminal 314.

### Fourth Embodiment

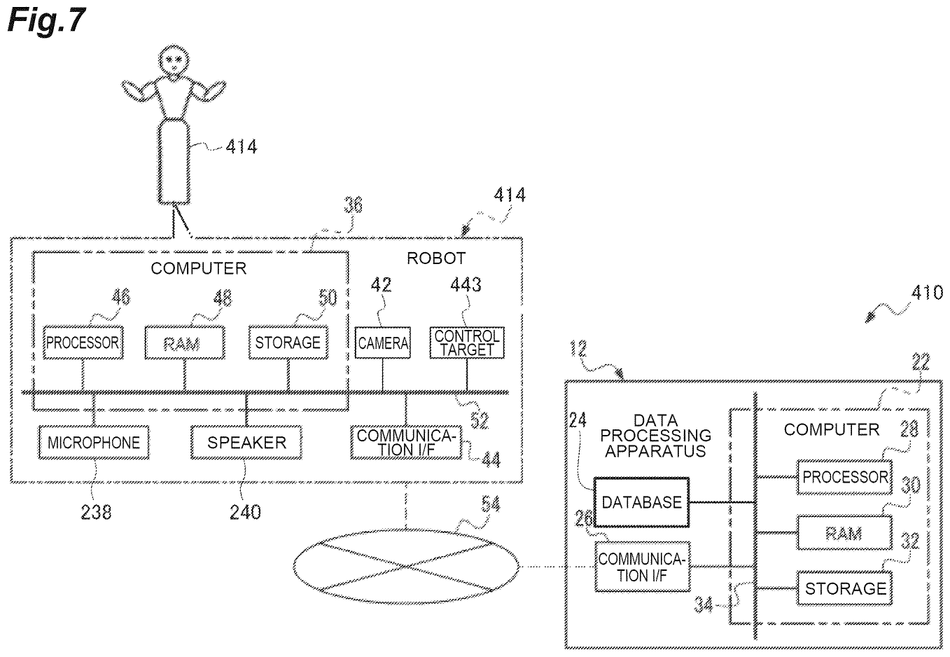

FIG. 7 illustrates an example of a configuration of a data processing system 410 according to a fourth embodiment.

As illustrated in FIG. 7, the data processing system 410 includes a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

The control target 443 includes a display device, an LED of an eye part, and motors that drive an arm, a hand, a leg, and the like. The posture and gestures of the robot 414 are controlled by controlling the motors of the arm, hand, leg, and the like. A part of the emotions of the robot 414 can be expressed by controlling these motors. Also, the facial expression of the robot 414 can also be expressed by controlling the light emission state of the LED of the eye part of the robot 414.

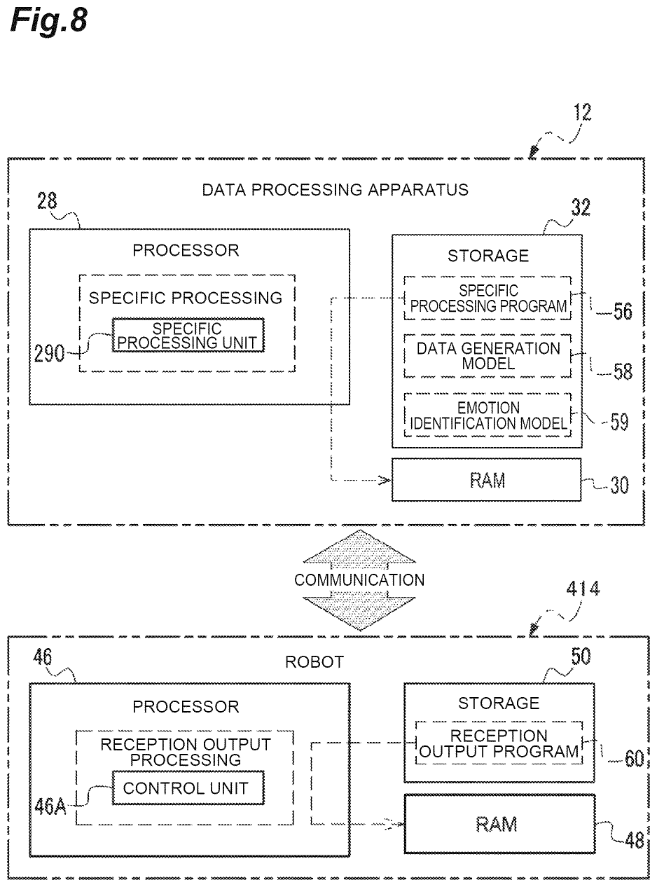

FIG. 8 illustrates an example of main functions of the data processing apparatus 12 and the robot 414. As illustrated in FIG. 8, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the robot 414, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the robot 414. In the following description, the data processing apparatus 12 is referred to as a “server”, and the robot 414 is referred to as a “terminal”.

### Example 4.1

Since the flow of the specific processing is the same as that in Example 1.1 described in the first embodiment, a description thereof is omitted.

### Example 4.2

Since the flow of the specific processing is the same as that in Example 1.2 described in the first embodiment, a description thereof is omitted.

The specific processing unit 290 transmits a result of the specific processing to the robot 414. In the robot 414, the control unit 46A causes the speaker 240 and the control target 443 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the robot 414.

Note that the emotion identification model 59 as an emotion engine may determine a user's emotion according to a specific mapping. For example, the emotion identification model 59 may determine the user's emotion according to an emotion map (see FIG. 9), which is a specific mapping. Also, the emotion identification model 59 may similarly determine the robot's emotion, and the specific processing unit 290 may perform specific processing using the robot's emotion.

FIG. 9 is a diagram illustrating an emotion map 400 on which a plurality of emotions are mapped. In the emotion map 400, emotions are arranged in concentric circles radiating from the center. The closer to the center of the concentric circles, the more primitive the state of the emotion is arranged. On the outer side of the concentric circles, emotions representing states and actions arising from a state of mind are arranged. Emotion is a concept that also includes affect and mental states. On the left side of the concentric circles, emotions generated from reactions that generally occur in the brain are arranged. On the right side of the concentric circles, emotions that are generally induced by situational judgment are arranged. In the upward and downward directions of the concentric circles, emotions that are generated from reactions that generally occur in the brain and are induced by situational judgment are arranged. Also, on the upper side of the concentric circles, “pleasant” emotions are arranged, and on the lower side, “unpleasant” emotions are arranged. In this way, in the emotion map 400, a plurality of emotions are mapped based on the structure in which emotions are generated, and emotions that are likely to occur at the same time are mapped close to each other.

These emotions are distributed in the 3 o'clock direction of the emotion map 400, and usually go back and forth between relief and anxiety. In the right half of the emotion map 400, situational awareness is superior to internal sensations, resulting in a calm impression.

Since the inside of the emotion map 400 represents the inside of the mind and the outside of the emotion map 400 represents actions, the further one goes to the outside of the emotion map 400, the more visible (manifested in action) the emotion becomes.

Here, human emotions are based on various balances such as posture and blood sugar levels, and show a state of unpleasantness when those balances move away from the ideal, and a state of pleasantness when they approach the ideal. In robots, automobiles, motorcycles, and the like as well, emotions can be created based on various balances such as posture and remaining battery level, so as to show a state of unpleasantness when those balances move away from the ideal, and a state of pleasantness when they approach the ideal. The emotion map may be generated based on, for example, Dr. Mitsuyoshi's emotion map (Research on a speech emotion recognition and brain physiological signal analysis system of affect, Tokushima University, doctoral dissertation: https://ci.nii.ac.jp/naid/500000375379). In the left half of the emotion map, emotions belonging to a region called “reaction” where sensation is dominant are arranged. Also, in the right half of the emotion map, emotions belonging to a region called “situation” where situational awareness is dominant are arranged.

In the emotion map, two emotions that promote learning are defined. One is an emotion around the middle of negative “remorse” and “reflection” on the situation side. That is, it is when a negative emotion such as “I never want to feel this way again” or “I don't want to be scolded anymore” arises in the robot. The other is an emotion around positive “desire” on the reaction side. That is, it is when there is a positive feeling such as “I want more” or “I want to know more”.

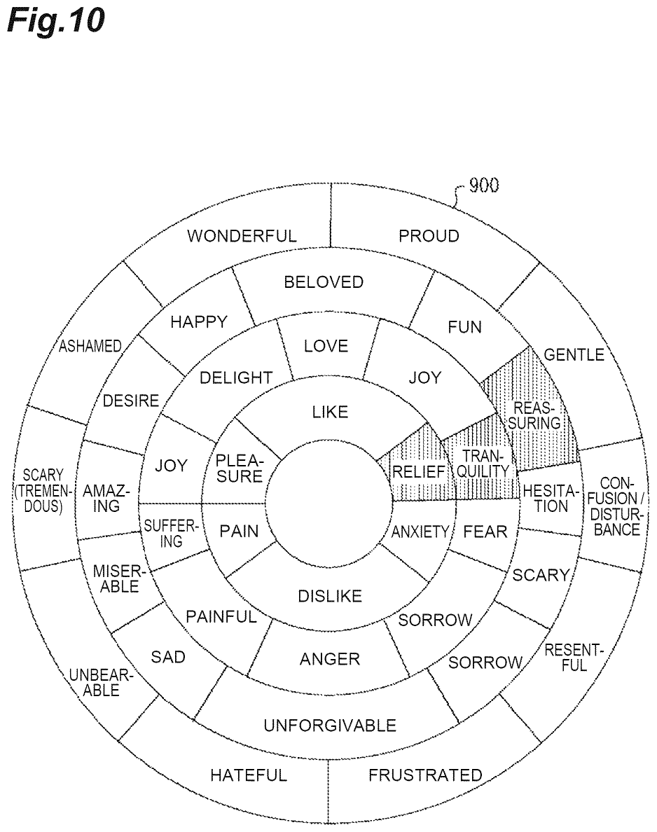

The emotion identification model 59 inputs a user input into a pre-trained neural network, acquires an emotion value indicating each emotion shown in the emotion map 400, and determines the user's emotion. This neural network is pre-trained based on a plurality of learning data that are combinations of user inputs and emotion values indicating each emotion shown in the emotion map 400. Also, this neural network is trained such that emotions arranged close to each other have close values, as in the emotion map 900 shown in FIG. 10. FIG. 10 shows an example in which a plurality of emotions, “relief,” “peace of mind,” and “reassured,” have close emotion values.

In learning of a neural network in the emotion identification model 59, a loss function may be designed such that a Euclidean distance between output vectors corresponding to semantically similar emotion labels (e.g., “relief” and “peace of mind”) is minimized based on the emotion map 900 shown in FIG. 10. For example, a technique such as Contrastive Learning is used to improve clustering accuracy of similar emotions. This makes it possible to quantitatively evaluate, on a computer, minute emotional fluctuations that were difficult to identify with conventional simple pattern matching. This quantified emotion value is used as a generation parameter of the NFT described above or a control signal of a robot, thereby realizing autonomous optimization of the system in response to a user's state.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program that runs on a personal computer, or an application that runs on a smartphone or the like. The method according to the present disclosure may be provided to a user in a Saas (Software as a Service) format.

An example form in which the specific processing is performed by one computer 22 has been described, but the technology of the present disclosure is not limited to this, and distributed processing for the specific processing may be performed by a plurality of computers including the computer 22. For example, the data generation model 58 may be provided in an external device of the data processing apparatus 12, and the external device may generate data according to the input data.

An example form in which the specific processing program 56 is stored in the storage 32 has been described, but the technology of the present disclosure is not limited to this. For example, the specific processing program 56 may be stored in a portable computer-readable non-transitory storage medium such as a USB (Universal Serial Bus) memory. The specific processing program 56 stored in the non-transitory storage medium is installed in the computer 22 of the data processing apparatus 12. The processor 28 executes the specific processing according to the specific processing program 56.

Also, the specific processing program 56 may be stored in a storage device such as a server connected to the data processing apparatus 12 via the network 54, and the specific processing program 56 may be downloaded in response to a request from the data processing apparatus 12 and installed in the computer 22.

Note that it is not necessary to store all of the specific processing program 56 in a storage device such as a server connected to the data processing apparatus 12 via the network 54, or to store all of the specific processing program 56 in the storage 32, and a part of the specific processing program 56 may be stored.

As hardware resources for executing the specific processing, various processors shown below can be used. Examples of the processor include a CPU, which is a general-purpose processor that functions as a hardware resource for executing the specific processing by executing software, that is, a program. Also, examples of the processor include a dedicated electric circuit, which is a processor having a circuit configuration specifically designed to execute specific processing, such as an FPGA (Field-Programmable Gate Array), a PLD (Programmable Logic Device), or an ASIC (Application Specific Integrated Circuit). A memory is built in or connected to any of the processors, and any of the processors executes the specific processing by using the memory.

The hardware resource that executes the specific processing may be configured by one of these various processors, or may be configured by a combination of two or more processors of the same type or different types (for example, a combination of a plurality of FPGAs, or a combination of a CPU and an FPGA). Also, the hardware resource that executes the specific processing may be one processor.

As an example of a configuration with one processor, first, there is a form in which one processor is configured by a combination of one or more CPUs and software, and this processor functions as a hardware resource for executing the specific processing. Second, there is a form in which a processor that realizes the functions of an entire system including a plurality of hardware resources for executing the specific processing with one IC chip, as represented by an SoC (System-on-a-chip) or the like, is used. In this way, the specific processing is realized using one or more of the various processors described above as hardware resources.

Furthermore, as a hardware structure of these various processors, an electric circuit in which circuit elements such as semiconductor elements are combined can be used. Also, the specific processing described above is merely an example. Therefore, it goes without saying that unnecessary steps may be deleted, new steps may be added, or the processing order may be changed within a scope that does not depart from the gist.

Generated data such as a “cooking menu” or “NFT art” generated by the specific processing unit 290 is not merely displayed, but parameters thereof can be dynamically adjusted according to a user's emotion vector. For example, when the emotion identification model 59 determines that the user's emotion is “anxiety” (lower left quadrant in FIG. 9), the specific processing unit 290 may execute an algorithm that shifts a color tone parameter of the NFT art to be generated to a warm color system and applies filter processing that lowers saturation to image data. Also, in the case of the robot 414, the control unit 46A may change a PID control parameter (proportional, integral, derivative gain) of each joint motor based on the specified emotion vector to suppress acceleration (jerk) of motion, thereby generating a physical motion that “snuggles up.” Thereby, abstract information called emotion can be converted into concrete technical numerical values such as physical device control parameters and image processing parameters and used.

The description and illustrations shown above are detailed descriptions of the parts related to the technology of the present disclosure, and are merely an example of the technology of the present disclosure. For example, the description regarding the above-described configuration, function, operation, and effect is a description regarding an example of the configuration, function, operation, and effect of the part related to the technology of the present disclosure. Therefore, it goes without saying that unnecessary parts may be deleted, new elements may be added, or replacements may be made to the description and illustrations shown above within a scope that does not depart from the gist of the technology of the present disclosure. Also, in order to avoid confusion and facilitate understanding of the parts related to the technology of the present disclosure, in the description and illustrations shown above, descriptions regarding common general technical knowledge and the like that do not require particular explanation for enabling the implementation of the technology of the present disclosure are omitted.

All documents, patent applications, and technical standards described in this specification are incorporated herein by reference to the same extent as if each individual document, patent application, and technical standard were specifically and individually indicated to be incorporated by reference.

It is to be understood that not all aspects, advantages and features described herein may necessarily be achieved by, or included in, any one particular example. Indeed, having described and illustrated various examples herein, it should be apparent that other examples may be modified in arrangement and detail.

A system comprising: an input unit for registering a digital product; a token generation unit for generating a unique digital token based on the registered digital product; a recording unit for recording the generated digital token on a blockchain; a browsing and purchasing unit for browsing and purchasing the digital product; a transfer unit for transferring the digital token to a purchaser's digital wallet when a purchase is completed; and a communication unit for promoting interaction between users.

In some examples, the system may include an interface for inputting detailed information of the digital product, wherein information such as a title, a description, a creator, a price, sales conditions, usage rights, and a number of editions of the product is registered, thereby preparing basic information for evaluating the value of the product.

In some examples, the system may include a communication function for a purchaser to post reviews and feedback on the digital product and exchange opinions with other users, thereby deepening understanding of the value of the digital product and promoting revitalization of the entire virtual store.

An example system for recording a transaction history of an artwork may include circuitry. The circuitry may be configured to: generate a unique digital token based on an input digital work; record the generated digital token on a blockchain; transfer the digital token to a digital wallet of a user when a purchase of the digital work by the user is completed; and provide a communication interface for an artist of the digital work and the user who purchased the digital work to interact.

In some examples, the circuitry may be further configured to: provide an input interface for inputting information of the digital work; and generate a public profile of the artist of the digital work based on information input from the input interface.

In some examples, providing the communication interface may include providing the communication interface for the user who purchased the digital work to post a review or feedback on the digital work, and for the artist of the digital work to post a story or a production process regarding the digital work.

An example method of recording a transaction history of an artwork may include: generating a unique digital token based on an input digital work; recording the generated digital token on a blockchain; transferring the digital token to a digital wallet of a user when a purchase of the digital work by the user is completed; and providing a communication interface for an artist of the digital work and the user who purchased the digital work to interact.

What is claimed is:

1. A system for recording a transaction history of an artwork, the system comprising circuitry
wherein the circuitry is configured to:
generate a unique digital token based on an input digital work;
record the generated digital token on a blockchain;
transfer the digital token to a digital wallet of a user when a purchase of the digital work by the user is completed; and
provide a communication interface for an artist of the digital work and the user who purchased the digital work to interact.

2. The system according to claim 1, wherein the circuitry is further configured to:
provide an input interface for inputting information of the digital work; and
generate a public profile of the artist of the digital work based on information input from the input interface.

3. The system according to claim 1, wherein providing the communication interface includes providing the communication interface for the user who purchased the digital work to post a review or feedback on the digital work, and for the artist of the digital work to post a story or a production process regarding the digital work.

4. A method of recording a transaction history of an artwork, the method comprising:
generating a unique digital token based on an input digital work;
recording the generated digital token on a blockchain;
transferring the digital token to a digital wallet of a user when a purchase of the digital work by the user is completed; and
providing a communication interface for an artist of the digital work and the user who purchased the digital work to interact.
